(19) United States
(12) Patent Application Publication
(10) Pub. No.: US 2005/0096209 A1
(43) Pub. Date: May 5, 2005

(54) Glass and method for producing glass

(75) Inventors: Junichirou Kase, Kanagawa (JP); Manabu Nishizawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Tokyo (JP)

(21) Appl. No.: 11/008,408

(22) Filed: Dec. 10, 2004

Related U.S. Application Data
(63) Continuation of application No. PCT/JP03/07267, filed on Jun. 9, 2003.

(30) Foreign Application Priority Data
Jun. 10, 2002 (JP) 2002-168847

(51) Int. Cl. C03C 3/087; C03C 3/091; C03C 3/11

(52) U.S. Cl. 501/56; 501/70; 501/62

(57) ABSTRACT

Glass having a small number of bubbles even without containing As₂O₃ or Sb₂O₃ and further without containing SO₃ and a method for producing glass without using either As₂O₃ or Sb₂O₃ as a refiner, are provided. Glass having a reduction degree such that Fe²⁺/(Fe²⁺+Fe³⁺) is at least 0.61, as the reduction degree of glass is represented by a ratio of Fe ions. A method for producing glass, which comprises melting raw material to produce glass comprising, as represented by mass percentage, at least 40% of Si as SiO₂, characterized in that the raw material contains an ammonium salt (except for ammonium sulfate and ammonium nitrate).

### TECHNICAL FIELD

The present invention relates to silicate glass and a method for producing silicate glass.

### BACKGROUND ART

Glass containing at least 40% of Si as SiO₂, as represented by mass percentage (hereinafter referred to as silicate glass) has been widely used for various applications such as a glass plate for a window pane or a glass substrate for a flat panel display or the like, a glass bottle, a glass tumbler, and a glass tube for a fluorescent lamp.

In addition to satisfying requirements for properties such as chemical durability, the silicate glass used for such applications, is required to satisfy a requirement that no bubbles of a size which brings about a problem to such applications be present, or if they are present, their number be within the allowable range.

In order to satisfy such a requirement which relates to the bubbles, raw material for the silicate glass usually contains a refiner to remove gas bubbles from molten glass obtained by melting the raw material.

As such a refiner, an oxide refiner such as As₂O₃ or Sb₂O₃, a sulfate refiner such as Na₂SO₄, K₂SO₄, CaSO₄ or BaSO₄, or NaCl has, for example, been known.

The above-mentioned requirement which relates to the bubbles varies depending on the application, and the requirement is particularly strict against a glass substrate for a flat panel display, especially against a glass substrate for a thin film transistor liquid crystal display (TFT-LD), an electro luminescence display (EL), a plasma display (PDP), a plasma assist liquid crystal display (PALC), a field emission display (FED) or the like. In other words, in the glass substrate for the flat panel display such as the glass substrate for TFT-LCD, it is required that the number of bubbles is small, even though they are small bubbles such that their sizes are at a level of a few tens μm.

For the glass substrate for TFT-LCD, silicate glass containing substantially no alkali metal oxides (hereinafter referred to as alkali-free glass) is used, and as its refiner, As₂O₃, Sb₂O₃ or a sulfate is used. Further, it is not desirable to use NaCl for alkali-free glass.

As₂O₃ or Sb₂O₃, particularly As₂O₃, is an excellent refiner from the viewpoint of removing gas bubbles from molten glass. However, it has a large environmental load, and it is desired to suppress its use.

On the other hand, the sulfate is an excellent refiner from the viewpoint of an extremely low environmental load, as compared with As₂O₃. However, in the case of alkali-free glass, its basicity is low, whereby solubility of SO₄²⁻ is low. As a result, there is a problem that the sulfate is inferior to As₂O₃ with a view to removing gas bubbles from molten glass.

It is an object of the present invention to provide silicate glass containing neither As₂O₃ nor Sb₂O₃, wherein the number of bubbles is small, and a process for producing the silicate glass, whereby such problems can be solved.

### DISCLOSURE OF THE INVENTION

The present Invention provides glass having a reduction degree such that Fe²⁺/(Fe²⁺+Fe³⁺) is at least 0.61, as the reduction degree of glass is represented by a ratio of Fe ions.

Further, the present invention provides a method for producing glass, which comprises melting raw material to produce glass comprising, as represented by mass percentage, at least 40% of Si as SiO₂, characterized in that the raw material contains an ammonium salt (except for ammonium sulfate and ammonium nitrate) (Method A of the present invention).

Further, the present invention provides a method for producing glass, which comprises melting raw material to produce glass comprising, as represented by mass percentage, at least 40% of Si as SiO₂, characterized by feeding an ammonium salt (except for ammonium sulfate and ammonium nitrate) to molten glass obtained by melting the raw material (Method B of the present invention).

Furthermore, the glass of the present invention is one produced by a melting method.

As a result of studying various materials for potentiality as a refiner for alkali-free glass, the present inventors have found that ammonium chloride is an excellent refiner with a view to removing gas bubbles from molten glass, and have arrived at the present invention. Usually, silicate glass such as alkali-free glass is produced by heating and melting raw material at a temperature of at least 1,000° C. to form molten glass, followed by cooling. Further, at the time of cooling, the glass may be formed into a desired shape, as the case requires.

The function of ammonium chloride to remove gas bubbles from the above-mentioned molten glass (this function will hereinafter be referred to as a refining function) is considered to be as follows.

Namely, since ammonium chloride in the above-mentioned raw material sublimes at 337.8° C., it will be instantaneously decomposed to ammonia gas (NH₃) and hydrogen chloride gas (HCl) at the time of melting the raw material at a temperature of at least 1,000° C.
NH₄Cl→NH₃+HCl

The ammonia gas will be decomposed to nitrogen gas (N₂) and hydrogen gas (H₂) at a high temperature of at least 1,000° C.
2NH₃→N₂+3H₂

The nitrogen gas has low solubility to molten glass, but, because of the foaming reaction, it is expected to provide some effect such that as a gas, it diffuses and flows into bubbles in molten glass, to increase the size of the bubbles thereby to facilitate surfacing and removal of bubbles.

On the other hand, with the hydrogen gas, it can be expected that a part thereof will be dissolved in molten glass temporarily and will be vaporized after from a few minutes to a few hours. Accordingly, the hydrogen gas becomes a foaming gas from the glass and facilitates surfacing and removal of bubbles in molten glass. The present inventors have found by Raman spectroscopy that glass having ammonium chloride added in the raw material (particularly alkali-free glass), generates many hydrogen foams at the initial stage of melting.

Further, molten glass becomes reducing by such generation of hydrogen gas, and when considered in comparison with the refining function of an oxide refiner and a sulfate refiner, it appears to facilitate diffusion of oxygen into molten glass from bubbles containing such oxygen gas in the step of cooling the molten glass.

On the other hand, the hydrogen chloride gas generated by the decomposition of ammonium chloride, is considered to provide a secondary effect by a reaction which, however, is not a main reaction. The hydrogen chloride gas will be dissociated into a proton (H⁺) and a chlorine ion (Cl⁻) at a high temperature of at least 1,000° C., and will be partially dissolved into molten glass.
HCl→H⁺+Cl⁻

Protons cannot exist stably in molten glass, and they are considered to react with hydroxide ions to form water (H₂O).
H⁺+OH→H₂O

When these two reactions are taken into consideration, it is considered that hydrogen chloride gas is eventually dissolved into molten glass in the form of chlorine ions while discharging water from molten glass.
HCl+OH⁻→Cl⁻+H₂O

It is considered that this water will diffuse and flow into micro bubbles present in molten glass, to increase the sizes of such bubbles, thereby to facilitate surfacing and removal of bubbles. Further, β-OH of the silicate glass produced from the raw material containing ammonium chloride is small, as compared with silicate glass produced from raw material containing no ammonium chloride. This is considered to support the above-mentioned mechanism for facilitating the surfacing and removal of bubbles by water.

In addition to ammonium chloride, an ammonium halide such as ammonium fluoride, ammonium bromide or ammonium iodide is effective as a refiner, since a similar reaction will thereby proceed.

An ammonium salt as a glass-constituting compound will also be an effective refiner. As such a salt, an ammonium borate such as ammonium tetraborate tetrahydrate may, for example, be mentioned. Hydrogen generated from ammonium groups, will facilitate the refining reaction of glass, and the rest will be decomposed into water and boric acid as a glass-constituting component, such being preferred in that no elements other than glass-constituting components will be included.

An ammonium salt of an organic acid also shows a remarkable refining effect. As such an ammonium salt, ammonium acetate, ammonium formate, ammonium carbonate, triammonium citrate, diammonium hydrogencitrate, ammonium dihydrogencitrate, ammonium fumarate, ammonium maleate, ammonium oxalate, ammonium succinate, ammonium hydrogentartrate or ammonium lactate may, for example, be mentioned. An ammonium salt of an organic acid is preferred as a refiner, since all reacted products will be gas components by the oxidation reaction at a high temperature, and no solid components will eventually remain in glass.

In a case where an ammonium halide such as ammonium chloride, ammonium fluoride, ammonium bromide or ammonium iodide, is used as the above-mentioned refiner, it is possible, by measuring Cl, F, Br or I dissolved in glass, to ascertain that the above-mentioned ammonium halide is used as the refiner.

On the other hand, with ammonium nitrate, ammonium sulfate or the like, no adequate refining effect will be observed. It is considered that the nitrate or sulfate groups will work as an oxidant, which hinders the refining reaction by hydrogen generated from the ammonium groups.

Thus, as the refiner in the present invention, an ammonium salt other than ammonium nitrate and ammonium sulfate is preferred.

### BEST MODE FOR CARRYING OUT THE INVENTION

Now, the composition of glass is represented by mass percentage, and the content of Si calculated as SiO₂O may simply be referred to as the SiO₂ content or SiO₂.

The glass of the present invention is silicate glass and to be used for various applications as mentioned above. A typical SiO₂ content is at least 40% and at most 80%.

The glass transition temperature (Tg) of the glass of the present invention is at least 500° C., preferably at most 800° C. The strain point is typically at least 500° C. in the case of soda lime silicate glass used for a window pane or the like, and typically at least 640° C., particularly at least 660° C. and at most 720° C., in the case of alkali-free glass used for a glass substrate for TFT-LCD or the like. Further, it is typically at least 570° C. and at most 650° C., in the case of high strain point glass used for a PDP substrate.

The thermal expansion coefficient (a value measured in accordance with JIS R3102 (1995)) of the glass of the present invention is typically from 25 to 50×10⁻⁷° C.⁻¹ (temperature range for measurement: 50° C. to 350° C.) in the case of alkali-free glass used for glass for a TFT-LCD substrate and typically from 75 to 90×10⁻⁷° C.⁻¹ (temperature range for measurement: 50° C. to 350° C.) in the case of high strain point glass used for a PDP substrate.

The glass of the present invention typically contains at least one element selected from the group consisting of Al, B, Mg, Ca, Sr, Ba and Zn, and comprises from 0 to 35% of Al₂O₃, from 0 to 25% of B₂O₃, from 0 to 50% of MgO+CaO+SrO+BaO+ZnO and from 19 to 59% of Al₂O₃+B₂O₃+MgO+CaO+SrO+BaO+ZnO. Preferably, MgO, CaO, SrO, BaO and ZnO are, respectively, from 0 to 30%, and MgO+CaO+SrO+BaO+ZnO is at least 1%. Here, for example, “from 0 to 35% of Al₂O₃” represents that Al₂O₃ is not essential but may be contained up to 35%.

In a case where the glass of the present invention is to be used as a substrate for TFT-LCD, the glass typically comprises as represented by mass percentage:

| | |
|---|---|
| SiO₂ | 45 to 70%, |
| Al₂O₃ | 5 to 25%, |
| B₂O₃ | 1 to 20%, |
| MgO | 0 to 10%, |
| CaO | 0 to 15%, |
| SrO | 0 to 15% and |
| BaO | 0 to 20%. |

Here, for example, “from 0 to 10 of MgO” represents that MgO is not essential but may be contained up to 10%.

SiO₂ is an essential component. If SiO₂ exceeds 70%, the melting property of the glass tends to deteriorate and devitrification tends to occur. It is preferably at most 68%, more preferably at most 67%. If it is less than 45%, increase of the specific gravity, decrease of the strain point, increase of the thermal expansion coefficient and deterioration of the chemical durability tend to occur. It is preferably at least 51%, more preferably at least 57%.

Al₂O₃ is a component to suppress phase separation of glass and to raise the strain point, and is essential. If it exceeds 25%, devitrification tends to occur and the chemical durability tends to deteriorate. It is preferably at most 22%, more preferably at most 19%. If it is less than 5%, the glass tends to undergo phase separation, and the strain point tends to be low. It is preferably at least 10%, more preferably at least 14%.

B₂O₃ is a component to lower the specific gravity, to increase the melting property of glass and to suppress devitrification, and is essential. If it exceeds 20%, the strain point tends to be low, the chemical durability tends to deteriorate, and further, volatilization tends to be remarkable at the time of melting the glass, whereby heterogeneity of glass tends to increase. It is preferably at most 16%, more preferably at most 12%. If it is less than 1%, the special gravity tends to increase, the melting property tends to deteriorate, and devitrification tends to occur. It is preferably at least 3%, more preferably at least 6%.

MgO is not essential, but it is a component to lower the specific gravity and to improve the melting property of glass. If it exceeds 10%, the glass tends to undergo phase separation, devitrification tends to occur, or the chemical durability tends to deteriorate. It is preferably at most 7%, and more preferably at most 5%. When MgO is incorporated, it is preferably contained in an amount of at least 0.1%. Particularly, in order to lower the specific gravity while maintaining the melting property, it is preferably contained in an amount of at least 1%.

CaO is not essential, but it may be incorporated up to 15% in order to increase the melting property of glass and to suppress devitrification. If it exceeds 15%, the specific gravity tends to increase, the thermal expansion coefficient tends to increase, and inversely, devitrification tends to occur. It is preferably at most 12%, more preferably at most 8%. When CaO is incorporated, it is preferably contained in an amount of at least 2%. It is more preferably at least 4%.

SrO is not essential, but it may be incorporated up to 15% in order to suppress phase separation of glass and devitrification. If it exceeds 15%, the specific gravity tends to increase, the thermal expansion coefficient tends to increase, and inversely, devitrification tends to occur. It is preferably at most 12%, more preferably at most 10%. When SrO is incorporated, it is preferably contained in an amount of at least 0.5%. It is more preferably at least 3%.

BaO is not essential, but it may be incorporated up to 20% in order to suppress phase separation of glass and devitrification. If it exceeds 20%, the specific gravity tends to increase, and the thermal expansion coefficient tends to increase. It is preferably at most 10%, more preferably at most 1%. Particularly, in a case where weight saving is important, it is preferably not incorporated. A particularly preferred composition comprises:

| | |
|---|---|
| SiO₂ | 51 to 68%, |
| Al₂O₃ | 10 to 22%, |
| B₂O₃ | 6 to 16%, |
| MgO | 1 to 7%, |
| CaO | 2 to 12%, |
| SrO | 0.5 to 10% and |
| BaO | 0 to 1%. |

In a case where the glass of the present invention is to be used as a PDP substrate, it typically comprises, as represented by mass percentage:

| | |
|---|---|
| SiO₂ | 50 to 75%, |
| Al₂O₃ | 0 to 15%, |
| B₂O₃ | 0 to 10%, |
| R₂O (R represents Li, Na or K) | 6 to 24%, |
| R′O (R′ represents Mg, Ca, Sr or Ba) | 12 to 27%, and |
| ZrO₂ | 0 to 10%. |

Here, the content of R₂O is the total amount of Li₂O+Na₂O+K₂O. Further, the content of R′O is the total amount of MgO+CaO+SrO+BaO. It preferably comprises from 0 to 3% of Li₂O, from 1 to 7% of Na₂O, from 3 to 20% of K₂O, from 0.5 to 7% of MgO, from 0.5 to 12% of CaO, from 0 to 10% of SrO and from 0 to 10% of BaO.

It preferably comprises:

| | |
|---|---|
| SiO₂ | 50 to 70%, |
| Al₂O₃ | 1 to 14%, |
| B₂O₃ | 0 to 3%, |
| R₂O (R represents Li, Na or K) | 8 to 24%, |
| R′O (R′ represents Mg, Ca Sr or Ba) | 12 to 25%, and |
| ZrO₂ | 0 to 6%. |

Here, the content of R₂O is the total amount of Li₂O+Na₂O+K₂O. Further, the content of R′O is the total amount of MgO+CaO+SrO+BaO. It preferably comprises from 0 to 3% of Li₂O, from 1 to 7% of Na₂O, from 3 to 20% of K₂O, from 0.5 to 7% of MgO, from 0.5 to 12% of CaO, from 0 to 10% of SrO and from 0 to 10% of BaO.

It more preferably comprises:

| | |
|---|---|
| SiO₂ | 50 to 65%, |
| Al₂O₃ | 2 to 12%, |
| B₂O₃ | 0 to 1%, |
| R₂O (R represents Li, Na or K) | 8 to 16%, |
| R′O (R represents Mg Ca Sr or Ba) | 13 to 24%, and |
| ZrO₂ | 0 to 5%. |

Here, the content of R₂O is the total amount of Li₂O+Na₂O+K₂O. Further, the content of R′O is the total amount of MgO+CaO+SrO+BaO. It preferably comprises from 0 to 2% of Li₂O, from 2 to 6% of Na₂O, from 5 to 14% of K₂O, from 1 to 6% of MgO, from 1 to 9% of CaO, from 0 to 6% of SrO and from 0 to 3% of BaO.

Further, in the glass of the present invention, Zn is not an essential component, but it may be incorporated up to 5%.

The glass of the present invention is characterized in that it contains NH₄⁺, even though it does not contain As₂O₃ or Sb₂O₃, namely, interior bubbles can be decreased by the surfacing effect of a gas component such as H₂ generated from the ammonium group. For this purpose, however, it is essential that a so-called reduction degree is high.

Using the content of Fe²⁺ and the content of Fe³⁺, the reduction degree of glass is usually represented by r=Fe²⁺/(Fe²⁺+Fe³⁺). In the case of the glass of the present invention, it is at least 0.61. If it is less than 0.61, bubbles tend to increase. It is preferably at least 0.8, more preferably at least 0.9, most preferably at least 0.95. In order to make the measurement of r possible, the glass of the present invention contains Fe ions as an essential component in a case where Fe ions are an index. The content of Fe (the total amount of Fe²⁺ and Fe³⁺) as calculated as Fe₂O₃, is required to be at least 0.0015%. If the content of Fe as calculated as Fe₂O₃, is less than 0.0015%, the measurement of r tends to be difficult. In order to simplify the measurement of r, the content of Fe as calculated as Fe₂O₃, is preferably at least 0.01%. Further, the content of Fe as calculated as Fe₂O₃, is typically at most 0.3%. In the case of glass for display, it is preferably at most 0.2%. If glass contains Fe more than 0.2%, the glass will be colored blue, such being undesirable as glass for display. It is preferably at most 0.1%, more preferably at most 0.05%.

The reduction degree of the glass of the present invention may be measured also by using an index other than Fe ions. For example, it is possible to estimate the state of Fe ions by analyzing Ti³⁺ ions present in a trace amount as impurities, by ESR (electron spin resonance). Further, it is also effective to remelt the glass and measure the potential of the glass to measure the oxygen activity.

The wavelength of light being from 400 to 700 nm is the visible light region. Glass which has absorbance in this region is not preferable for a glass substrate for display. According to the CRT standards (the characteristic standards for cathode ray tubes “EIAJ ED 2138A” by Electronic Industries Association of Japan), the typical wavelength of visible light is represented by 546 nm. The glass of the present invention is suitable for a glass substrate, and it preferably has a transmittance of at least 85% (particularly at least 90%) of light with a wavelength of 546 nm, when the thickness of the substrate is 0.7 mm. When the thickness of the glass substrate is not 0.7 mm, evaluation is possible by measuring the thickness of the substrate, transmittance and reflectance and calculating the transmittance as of a thickness of 0.7 mm.

It is known that the transmittance of ultraviolet rays having a wavelength of about 300 nm is lowered by absorption by Fe³⁺. Since the above-mentioned r of the glass of the present invention is high, the transmittance of ultraviolet rays is easily improved. When the thickness of the substrate is 0.7 mm, the glass of the present invention has a transmittance of at least 60%, preferably at least 77%, of ultraviolet rays having a wavelength of 300 nm. In the present invention, if the content of Fe as calculated as Fe₂O₃ is at most 0.2%, the above-mentioned transmittance may be made to be at least 80% as coupled with the refining function.

In a case where the glass of the present invention is produced by using an ammonium salt, the produced glass contains a small amount of NH₄⁺.

Whether or not the glass of the present invention contains NH₄⁺ may be examined, for example, as follows.
(1) The glass is pulverized and accurately weighed in an amount of about 1 g on a platinum dish.
(2) Such about 1 g of the glass powder is wetted by a small amount of deionized water.
(3) 10 ml of HF (concentration: 29 mol/l) and 5 ml of H₂SO₄ (concentration: 9 mol/l) are added to the glass powder wetted by deionized water, and thermolysis is carried out on a sand bath.
(4) After cooling, 5 ml of HF (concentration: 29 mol/l) is again added, and thermolysis is carried out on the sand bath. Heating is continued until white smoke of sulfuric acid rises, and the solution becomes to be in a syrup state.
(5) After cooling, the residue and the decomposed solution are washed out by deionized water and put into a flask for Kjeldahl distillation. At this time, the volume of the solution is adjusted to be 300 ml.
(6) Boiling stones are put into the above flask, and this flask is installed in the Kjeldahl distillation apparatus.
(7) 50 ml of H₂SO₄ (concentration: 25 mmol/l) is put into a graduated cylinder which is a receiver of the Kjeldahl distillation apparatus. 40 ml of a NaOH aqueous solution (concentration: 40 g/l) is added into the flask through an injection funnel.
(8) The above flask is heated to carry out distillation.
(9) When about 140 ml is distilled off, the distillation is terminated, and the distillate is adjusted to 200 ml by deionized water.
(10) NH₄⁺ in the distillate is detected by ion chromatography.

In the present invention, when the content of NH₄⁺ in the glass is quantified to be at least 0.0001%, the glass is deemed to contain NH₄⁺.

Further, with respect to the Kjeldahl distillation apparatus, one which is shown in “42. Ammonium Ion (NH₄⁺)” of JIS K0102 “Plant Waste Water Test” (1993) is used.

Further, the procedure of distillation is also in accordance with the method for analyzing ammonium ions as prescribed in “42” of JIS K0102 and the method for analyzing organic nitrogen as prescribed in “44. organic nitrogen” thereof.

The present inventors used an ion chromatography apparatus manufactured by Dionex Corporation.

As a precolumn and a separation column, Ion-Pak CG14 and Ion-Pak CS14, manufactured by Dionex Corporation were respectively used.

As a suppresser apparatus, an auto suppresser (recycling mode) was used. As a detector, a conductance meter was used.

As an eluting solution, methansulfonic acid (concentration: 10 mmol/l) was used, and the flow rate of the eluting solution was set to be 1.0 ml/min.

The content of NH₄⁺ in the glass of the present invention is preferably from 0.0001 to 0.01%, particularly preferably at least 0.0004%. It is more preferably from 0.0004 to 0.001%.

In a case where the glass of the present invention contains at least one element selected from the group consisting of Cl, F, Br and I, the content thereof is typically from 0.03 to 1%, particularly preferably from 0.05 to 1%. If the above content exceeds 1%, the strain point or the chemical durability tends to deteriorate, when the glass of the present invention is used for the TFT-LCD glass substrate. The above content is preferably at most 0.5%. Under such a condition that the refining function is remarkable, it is preferably at least 0.05%, more preferably at least 0.08%.

The glass of the present invention does not contain S, or if it contains S, the content as calculated as SO₃ is preferably at most 0.005%. If its content as calculated as SO₃ exceeds 0.005%, the reduction degree of the glass becomes so small that enough refining function cannot be obtained, or due to reboiling of SO₃, bubbles tend to be generated and tend to increase. Further, even if the content of S is a trace amount, the glass may not sometimes be used as a glass substrate for a flat panel display as amber coloration results due to co-existence of S and Fe²⁺ or Fe³⁺. In order to prevent such coloration, the content as calculated as SO₃ is preferably at most 0.002%, more preferably at most 0.0005%.

The glass of the present invention contains neither As nor Sb, or if it contains As and/or Sb, the total of the content as calculated as As₂O₃ and the content as calculated as Sb₂O₃ is preferably at most 0.1%, more preferably, at most 0.01%.

The glass of the present invention does not contain Sn, or even if it contains Sn, the content as calculated as SnO₂ is preferably at most 0.02%. If it exceeds 0.02%, the reduction degree of the glass by ammonium chloride or the like tends to be low, or Sn tends to be present in the glass in the form of a metallic colloid, thereby to color the glass, whereby the glass tends to be hardly useful as a substrate for a flat panel display.

The glass of the present invention preferably contains no oxide of Ti, V, Nb, Mo, Ce or the like. Since these oxides will release oxygen in the reduced glass, the reduction degree by ammonium chloride tends to be low, or they tend to be metal ions thereby to color the glass, whereby the glass tends to be hardly useful as a substrate for a flat panel display.

The glass of the present invention preferably does not contain Se, Cu, Pb, Ni, Cd, Mn, Ge, Cs or the like. These elements tend to be present in glass in the form of a metallic colloid thereby to color the glass, whereby the glass tends to be hardly useful as a glass substrate for a flat panel display.

The glass of the present invention is a glass which contains, as represented by mass percentage, at least 40% of Si as calculated as SiO₂, and it contains either NH₄⁺ or Cl, contains no S (or if it contains S, the content as calculated as SO₃ as represented by mass percentage, is at most 0.005%), contains neither As nor Sb (or if it contains As and/or Sb, the total of the content as calculated as As₂O₃ and the content as calculated as Sb₂O₃, as represented by mass percentage, is at most 0.1%), and contains no Sn (or if it contains Sn, the content as calculated as SnO₂ as represented by mass percentage, is at most 0.02%).

Particularly, the content of Si as calculated as SiO₂, is preferably at most 80%, as represented by mass percentage. NH₄⁺is preferably contained in an amount of from 0.0001 to 0.01%, particularly from 0.0004 to 0.001%, as represented by mass percentage. At least one element selected from the group consisting of Cl, F, Br and I is contained in an amount of from 0.03 to 1%, as represented by mass percentage. Particularly preferably, Cl is contained in an amount of from 0.05 to 1%.

Further, at least one element selected from the group consisting of Al, B, Mg, Ca, Sr, Ba and Zn is contained, and the contents as calculated as the following oxides, are preferably from 0 to 35% of Al₂O₃, from 0 to 25% of B₂O₃, from 0 to 50% of Mgo+CaO+SrO+BaO+Zno and from 19 to 59% of Al₂O₃+B₂O₃+Mgo+CaO+SrO+BaO+ZnO, as represented by mass percentage.

Further, the above glass preferably contains from 45 to 70% of SiO₂, from 5 to 25% of Al₂O₃, from 1 to 20% of B₂O₃, from 0 to 10% of MgO, from 0 to 15% of CaO, from 0 to 15% of SrO and from 0 to 20% of BaO or contains from 50 to 75% of SiO₂, from 0 to 15% of Al₂O₃, from 0 to 10% of B₂O₃, from 6 to 24% of R₂O (R represents Li, Na or K), from 12 to 27% of R′O (R′ represents Mg, Ca, Sr or Ba) and from 0 to 10% of ZrO₂.

Further, the above glass preferably contains from 0.0001 to 0.01% of NH₄⁺and from 0.05 to 1% of Cl.

The glass of the present invention may be produced, for example, by the method A or the method B, of the present invention.

The method A of the present invention will be described.

The raw material mixed to obtain silicate glass of the desired composition is heated and melted to obtain molten glass. The molten glass is subjected to defoaming, homogenization, etc. and then cooled. Homogenization of the molten glass may be facilitated, for example, by stirring. Further, the molten glass is usually molded into a plate glass while being cooled.

The above-mentioned raw material is usually made of silica sand, etc. However, it may contain cullet.

The melting may be carried out, for example, by putting the raw material into a suitable crucible and putting the crucible into a furnace such as an electric furnace maintained at a high temperature, or by continuously putting the raw material into a glass melting furnace maintained at a high temperature, such that the highest temperature part is, for example, from 1500 to 1600° C.

In the method A of the present invention, the raw material is used which contains the above-mentioned ammonium salt such as ammonium chloride being an excellent refining agent, as mentioned above.

The ratio of ammonium chloride contained in the raw material is from 0.1 to 10 parts, per 100 parts by mass of the glass obtained by melting the raw material. Namely, ammonium chloride is preferably added to the glass raw material in an amount corresponding to from 0.1 to 10 parts, per 100 parts by mass of the glass obtained by melting the raw material. If it is less than 0.1 part, the refining function of ammonium chloride tends to be low. It is more preferably at least 0.2 part. In a case where the time during which the glass is maintained in a molten state is long, the above ratio is preferably at least 0.3 part, more preferably at least 1.0 part. On the other hand, if the above ratio exceeds 10 parts, ammonia gas generation, hydrogen chloride gas generation, chloride gas generation, or generation of another gas, tends to increase at the time of melting. It is more preferably at most 3 parts.

Further, NH₄⁺ and Cl may be contained in the molten glass. However, they are in an extremely small amount, so that when the amount of ammonium chloride to be added to the raw material is calculated, the mass of the glass containing NH₄⁺ or Cl may be taken as 100 parts.

The raw material contains no sulfate, or if it contains a sulfate, the total content is preferably at most 0.01%, per 100 parts by mass of the glass obtained by melting the raw material. Namely, the sulfate is preferably added to the glass raw material preferably in an amount corresponding to at most 0.01 part, per 100 parts by mass of the glass obtained by melting the raw material. If it exceeds 0.01 part, the refining function of ammonium chloride tends to be low. Further, the glass may not sometimes be used as a glass substrate for a display as amber coloration results.

Further, in a case where a small amount of the sulfate is used as a refiner, the glass obtained by melting may contain SO₃, etc. originated from the sulfate. However, they are in an extremely small amount, so that when the amount of ammonium chloride to be added to the raw material is calculated, the glass containing SO₃, etc. may be taken as 100 parts.

The same applies to the following case of As, Sb and SnO₂. Namely, in a case where a small amount of As, Sb, SnO₂, etc. is used, the glass obtained by melting may contain As, Sb, SnO₂, etc. However, they are in an extremely small amount, so that when the amount of As, Sb, SnO₂, etc. to be added to the raw material is calculated, the glass containing As, Sb, SnO₂, etc. may be taken as 100 parts.

The raw material contains neither As nor Sb, or if it contains As and/or Sb, the total of the content as calculated as As₂O₃ and the content as calculated as Sb₂O₃ is preferably at most 0.1 part, per 100 parts by mass of the glass obtained by melting the raw material. Namely, they are added to the glass raw material preferably in such an amount that the total of the content as calculated as As₂O₃ and the content as calculated as Sb₂O₃ corresponds to at most 0.1 part, per 100 parts by mass of the glass obtained by melting the raw material.

The raw material does not contain SnO₂, or if it contains SnO₂, the total content is at most 0.03 part, per 100 parts by mass of the glass obtained by melting the raw material. Namely, SnO₂ is added to the glass raw material preferably in an amount corresponding to at most 0.03 part, per 100 parts by mass of the glass obtained by melting the raw material. It is more preferably at most 0.02 part. If it exceeds 0.02 part, particularly exceeds 0.03 part, the refining function of ammonium chloride tends to be low.

The raw material may contain a fluoride or a chloride in addition to ammonium chloride. For example, by using ammonium chloride in combination with strontium chloride hydrate (SrCl₂.6H₂O) or barium chloride hydrate (BaCl₂.2H₂O), the content of Cl in the glass can be increased while maintaining the reduction degree to be constant.

The glass of the present invention can be produced, for example, in the following manner, by employing the method A of the present invention. Namely, materials of the respective components of the glass of the present invention, which are commonly employed, are mixed so as to attain the desired composition, thereby to obtain a raw material, which is then continuously put into a glass melting furnace having the highest temperature of e.g. from 1500 to 1600° C., and melted to obtain molten glass. Further, a proper amount of ammonium chloride is added to the starting material.

Then, the molten glass is maintained at a temperature of from 1200 to 1500° C. for defoaming or defoamed by the reduced pressure defoaming technique.

The defoamed molten glass is, for example, formed into a plate glass. As the forming method, a float method, a fusion method or a slot down draw method may, for example, be mentioned. The plate glass is annealed and then cut to obtain a glass substrate for TFT-LCD, a glass substrate for PDP or the like.

Now, the method B of the present invention will be explained.

In the method A of the present invention, ammonium chloride is incorporated to the raw material to have NH₄⁺ incorporated to the molten glass, i.e. to have H₂ gas or another gas generated. Whereas, in the method B of the present invention, ammonium chloride is supplied directly to the molten glass to have NH₄⁺ incorporated to the molten glass, i.e. to have H₂ gas or another gas generated. As the method for supplying ammonium chloride directly to the molten glass, a method of spreading ammonium chloride powder on the surface of the molten glass may, for example, be mentioned.

Further, the explanation about the sulfate and SnO₂ in the method A of the present invention is also applicable to the method B of the present invention.

The method B of the present invention may be used in combination with the method A of the present invention.

According to the method A and the method B of the present invention, it will be possible to produce alkali-free glass having a small number of bubbles, without using an oxide refiner such as As₂O₃ or Sb₂O₃ or a sulfate refiner.

### EXAMPLES

From “SiO₂” to “Fe₂O₃” in Table 1 show the mass proportions of the respective components when the total amount of from “SiO₂” to “BaO” components of the glass obtained in each Example of the present invention, is taken as 100, and “ammonium salt/chloride” to “SO₃”, show the amounts, etc. to be added to the glass raw material. Further, the composition in the glass raw material used in each Example was almost the same as the composition of from “SiO₂” to “Fe₂O₃” in Table 1. Table 2 shows the properties, etc. of the glass in each Example.

So that the total of from “SiO₂” to “BaO” in Table 1 would become 100, industrial materials containing substantially no sulfate were mixed to obtain the composition shown by the mass proportions, and iron oxide, an ammonium salt (ammonium chloride), a chloride (strontium chloride hydrate) or a sulfate (calcium sulfate) was incorporated thereto to obtain 250 g of a raw material. Further, the content of the iron oxide, the chloride or the sulfate was adjusted so as to be the content of Fe as calculated as Fe₂O₃, the content of Cl or the content of SO₃, respectively, shown by the mass ratio wherein the total amount of the above “SiO₂” to “BaO” in Table is taken as 100. Further, in a case where the mass of the glass is taken as 100 parts, the content of the ammonium salt in the raw material is substantially same as the value of the mass ratio of the ammonium salt in Table 1. In Tables “−” means “not contained” and “not” means “not measured”.

Further, in Examples of the present invention, substantially no oxide of Ti, V, Nb, Mo or Ce was contained. Further, substantially no Se, Cu, Pb, Ni, Cd, Mn, Ge or Cs was contained.

250 g of the above raw material was put into a platinum crucible and, by using an electric furnace in the air, maintained and melted at 1600° C. in Examples 1 to 3 and 5 to 7 and at 1550° C. in Example 4 for one hour respectively, to obtain the molten glass. This molten glass was cast on a carbon plate for solidification, followed by annealing.

r, the amount of dissolved NH₄⁺ (unit: 10⁻⁴%), the amount of dissolved Cl (unit: %), β-OH (unit: mm⁻¹) and the number of bubbles (unit: number/cm³), of the obtained glass were measured. Further, in Example 4 to 7, the amount of dissolved NH₄⁺ was not measured.

r: Fe²⁺ in the glass was quantified by bipyridyl absorptiometry, and the total Fe ions, i.e. Fe²⁺+Fe³⁺, were quantified by ICP emission spectral analysis. Further, r in Example 6 was not measured, but, it is estimated to be 0.60.

Amount of dissolved Cl: The glass was pulverized, and it was measured by a fluorescent X-ray method. Further, in Example 5, it was not measured.

β-OH: The transmittance of infrared rays was measured, and β-OH was obtained by dividing the transmittance at 4000 cm⁻¹ by the transmittance at 3570 cm⁻¹. Further, in Examples 5 and 6, it was not measured.

Number of bubbles: The glass was cut and polished to obtain a glass plate having a thickness of 2 mm, and the number of bubbles of about 10 μm or larger was counted by a stereoscopic microscope and divided by the volume of the glass plate to obtain the number of bubbles. In the present evaluation, bubbles in glass after one hour of melting and maintaining, was evaluated. The number of bubbles is preferably at most 1000 pcs/cm³, more preferably at most 500 pcs/cm³.

The number of bubbles rapidly decreases as the melting time is extended. If the number of bubbles is at most 2000 pcs/cm³ in the present evaluation, the number of bubbles becomes at most 1 pcs/cm³ after 6 hours of melting under the same condition. When the number of bubbles is at most 1000 pcs/cm³ in the present evaluation, after 6 hours of melting, the number of bubbles decreases to a level which can be regarded as substantially zero. If the number of bubbles is less than 500 pcs/cm³ in the present evaluation, when applied also to many continuously melting furnaces, it is considered that the number of bubbles will decrease to a level which can be regarded as substantially zero. Further, the melting time in the float process is usually at least 6 hours.

Transmittance: With respect to the glass in Example 1 to 3, the glass was cut and polished to obtain a glass plate having a thickness of 0.7 mm, and a portion having no bubble was selected to measure the spectral transmittance of that portion. For the measurement, self-recording spectrophotometer U-3500, manufactured by Hitachi, Ltd. was used, and the transmittances (%) of 546 nm and 300 nm were obtained.

With respect to the specific gravity, the thermal expansion coefficient, the glass transition temperature (Tg), the strain point, the Young's modulus and the HCl durability, 500 g of glass which had the same composition and the same material constitution as in Examples 3 to 5, was melted in the platinum crucible at 1600° C. for 6 hours, and a glass specimen having bubbles completely removed, was prepared, and the measurements were carried out.

Specific gravity: Measured by the Archimedes' method.

Thermal expansion coefficient and glass transition temperature (Tg): By a thermomechaniacl analysis instrument (TMA), the thermal expansion coefficient (10⁻⁷° C.⁻¹ (measuring temperature range: from 50 to 350° C.)) was measured. From the temperature at the inflection point in the thermal expansion curve, Tg (° C.) was read out.

Strain point: The strain point (° C.) was measured by Fibre Elongation Method (JIS R3103-2 2001).

Young's modulus: Glass having a thickness of 10 mm (50 mm×50 mm×10 mm) was prepared, and the Young's modulus (Gpa) was measured by an ultrasonic pulse method.

HCl durability: The glass was dipped in hydrochloric acid having a concentration of 0.1 mol/litter at 90° C. for 20 hours, and the mass decrease per unit area was obtained from the mass change of the glass by dipping and the surface area of the glass.

Since the mass proportion of components other than from “SiO₂” to “BaO” is a trace amount, the contents of from “SiO₂” to “Fe₂O₃” in the above obtained glass are the same as ones calculated from the values of from “SiO₂” to “Fe₂O₃” in Table 1.

With respect to impurities in the glass in Example 3, i.e. elements other than those identified in the Table, qualitative analyses were carried out by an Inductively Coupled Plasma Mass Spectrometry meter (ICP-MS; manufactured by Agilent Technologies, Inc). With respect to elements quantifiable among those detected by ICP-MS, quantitative analyses were carried out by a standard addition method. As a result, the impurity element having the highest concentration was Ti, and it was 45 ppm. The second was Pb, and it was 1.5 ppm. Ni was 1.1 ppm. Other impurity elements were all less than 1 ppm. Each of them was in such an amount that may be regarded as substantially not contained. As, Sb and Sn were respectively lower than the threshold of quantitative analysis. SO₃ was measured by a quantitative analysis by fluorescent X-ray and was found to be 8 ppm (0.0008%).

Further, the amount of dissolved SO₃ in the glass in Example 7 was 0.001%.

Examples 1 to 5 are Examples of the method A of the present invention, and Examples 6 and 7 are Comparative Examples. The raw material in Examples 1 to 5 contains only ammonium chloride as the refiner and contains substantially no SO₃. Further, it contains substantially no As or Sb. Both NH₄⁺ and Cl are contained in the glass.

The glass in Examples 1 to 5 is suitable for a glass substrate for TFT-LCD.

The results in Examples 1 to 3 show that β-OH decreases as the amount of dissolved Cl in the glass increases. This is considered attributable to that as the content of ammonium chloride in the raw material increased, H₂O discharged from the molten glass increased.

Further, it shows that as the content of ammonium chloride in the raw material increased, r increased, and the number of bubbles decreased.

The refining effects in the present invention may depend on the composition of the glass. However, in the case of alkali-free glass, the smaller the total amount of alkaline earth metal oxides (MgO, CaO, SrO and BaO) in the composition is, the smaller the amount of the refiner required to be added tends to be to obtain remarkable refining effects. Namely, the refining function of the present invention is attributable to the function of hydrogen gas, and it is considered that in the case of such a composition that the oxygen activity is low in glass, i.e. the total content of the above alkaline earth metal oxides is low, the refining function is remarkable.

The glass in Examples 1 to 3 contains 11.7% of alkaline-earth metal oxides as calculated as mol %, while in Example 4 14.5%, and in Example 5 12.3%. Particularly, the difference in the number of bubbles between Example 3 and Example 4 is considered to be attributable to this effect. The content of alkaline earth metal oxides is preferably at most 20%, more preferably at most 15%, particularly preferably at most 12%.

TABLE 1

| Example | 1 | 2 | 3 | 4 | 5 | 6 | 7 |
|---|---|---|---|---|---|---|---|
| SiO₂ | 64 | 64 | 64 | 60 | 58.9 | 64 | 64 |
| Al₂O₃ | 17 | 17 | 17 | 17.3 | 16.1 | 17 | 17 |
| B₂O₃ | 8 | 8 | 8 | 8 | 8.6 | 8 | 8 |
| MgO | 1.4 | 1.4 | 1.4 | 3.1 | 0.8 | 1.4 | 1.4 |
| CaO | 6.2 | 6.2 | 6.2 | 3.6 | 4.3 | 6.2 | 6.2 |
| SrO | 3.4 | 3.4 | 3.4 | 7.9 | 1.9 | 3.4 | 3.4 |
| BaO | 0 | 0 | 0 | 0.1 | 9.4 | 0 | 0 |
| Fe₂O₃ | 0.07 | 0.07 | 0.07 | 0.07 | 0.02 | 0.07 | 0.07 |
| Ammonium | NH₄Cl | NH₄Cl | NH₄Cl | NH₄Cl | NH₄Cl | NH₄Cl | SrCl₂.6H₂O |
| salt/chloride | | | | | | | |
| Amount of | 0.75 | 1.06 | 1.51 | 1.51 | 0.98 | 0.75 | — |
| ammonium | | | | | | | |
| salt to be added | | | | | | | |
| NH₄⁺ | 0.25 | 0.36 | 0.51 | 0.51 | 0.33 | 0.25 | Not |
| Cl | 0.5 | 0.7 | 1 | 1 | 0.65 | 0.5 | 1 |
| Sulfate | — | — | — | — | — | CaSO₄ | — |
| SO₃ | Not | Not | Not | Not | Not | 0.2 | Not |

TABLE 2

| Example | 1 | 2 | 3 | 4 | 5 | 6 | 7 |
|---|---|---|---|---|---|---|---|
| r | 0.80 | 0.97 | 0.99 | 0.97 | Not | Not | 0.6 |
| Dissolved | 4 | 6 | 8 | Not | Not | Not | Not |
| NH₄⁺ | | | | | | | |
| Dissolved | 0.12 | 0.15 | 0.2 | 0.3 | Not | 0.1 | 0.18 |
| Cl | | | | | | | |
| Dissolved | Not | Not | 0.0008 | Not | Not | Not | 0.001 |
| SO₃ | | | | | | | |
| β-OH | 0.27 | 0.25 | 0.22 | 0.24 | Not | Not | 0.28 |
| Number of | 1000 | 200 | 20 | 500 | 300 | 2000 | 3400 |
| bubbles | | | | | | | |
| Transmittance | 91.3 | 90.8 | 90.4 | Not | Not | Not | Not |
| (546 nm) | | | | | | | |
| Transmittance | 63.4 | 77.7 | 87.9 | Not | Not | Not | Not |
| (300 nm) | | | | | | | |
| Specific | Not | Not | 2.42 | 2.50 | 2.54 | Not | Not |
| gravity | | | | | | | |
| Thermal | Not | Not | 33 | 38 | 39 | Not | Not |
| expansion | | | | | | | |
| coefficient | | | | | | | |
| Tg | Not | Not | 742 | 728 | 726 | Not | Not |
| Strain | Not | Not | 690 | 670 | 670 | Not | Not |
| point | | | | | | | |
| Young's | Not | Not | 75 | 76 | 70 | Not | Not |
| Modulus | | | | | | | |
| HCl | Not | Not | 0.06 | 0.13 | 0.08 | Not | Not |
| durability | | | | | | | |

From “SiO₂” to “Fe₂O₃” in Table 3 show the mass proportions of the respective components when the total amount of from “SiO₂” to “BaO” components of the glass obtained in each Example of the present invention is taken as 100, and from “ammonium salt” to “NH₄⁺” show the amounts, etc. to be added to the glass raw material. Further, the composition in the glass raw material used in each Example was almost the same as the composition from “SiO₂” to “Fe₂O₃” in Table 3. Table 4 shows the properties, etc. of the glass in each Example.

So that the total of from “SiO₂” to “BaO” in Table 3 would become 100, industrial materials containing substantially no sulfate were mixed to obtain the composition shown by the mass proportions, and iron oxide and an ammonium salt (ammonium bromide, ammonium iodide, ammonium tetra borate tetrahydrate, diammnonium hydrogen citrate or ammonium sulfate) were incorporated thereto to obtain 250 g of a raw material. The ammonium salt was added in such an amount that the content of NH₄⁺ would be 0.25, based on the mass proportion such that the above total of from “SiO₂” to “BaO” was taken as 100.

Further, in a case where the mass of the glass is taken as 100 parts, the content of the ammonium salt in the raw material is substantially the same as the value of the mass ratio of the ammonium salt in Table 3.

250 g of the above raw material was put into a platinum crucible and, by using an electric furnace in the air, maintained and melted at 1600° C. for one hour, to obtain the molten glass. This molten glass was cast on a carbon plate for solidification, followed by annealing. The number of bubbles in the obtained glass was counted in the same manner as in Table 1.

Since the mass proportion of components other than from “SiO₂” to “BaO” is a trace amount, the contents of from “SiO₂” to “Fe₂O₃” in the above obtained glass are the same as ones calculated from the values of from “SiO₂” to “Fe₂O₃” in Table 3.

TABLE 3

| Example | 8 | 9 | 10 | 11 | 12 |
|---|---|---|---|---|---|
| SiO₂ | 64 | 64 | 64 | 64 | 64 |
| Al₂O₃ | 17 | 17 | 17 | 17 | 17 |
| B₂O₃ | 8 | 8 | 8 | 8 | 8 |
| MgO | 1.4 | 1.4 | 1.4 | 1.4 | 1.4 |
| CaO | 6.2 | 6.2 | 6.2 | 6.2 | 6.2 |
| SrO | 3.4 | 3.4 | 3.4 | 3.4 | 3.4 |
| BaO | 0 | 0 | 0 | 0 | 0 |
| Fe₂O₃ | 0.03 | 0.03 | 0.03 | 0.03 | 0.03 |
| Ammonium salt | NH₄Br | NH₄I | (NH₄)₂B₄O₇.4H₂O | (NH₄)₂HC₆H₅O₇ | (NH₄)₂SO₄ |
| Amount | 1.38 | 2.04 | 1.86 | 1.59 | 0.93 |
| of ammonium | | | | | |
| salt to be added | | | | | |
| NH₄⁺ | 0.25 | 0.25 | 0.25 | 0.25 | 0.25 |

TABLE 4

| Example | 8 | 9 | 10 | 11 | 12 |
|---|---|---|---|---|---|
| r | 0.86 | 0.83 | 0.79 | 0.83 | 0.45 |
| Number of | 300 | 100 | 80 | 600 | 4000 |
| bubbles | | | | | |

Table 5 and Table 6 show an Example of a glass substrate for PDP. From “SiO₂” to “Fe₂O₃” in Table 5 show the mass proportions of the respective components when the total amount of from “SiO₂” to “K₂O” components of the glass obtained in the Example of the present invention, is taken as 100, and “ammonium salt” to “NH₄⁺” show the amounts, etc. to be added to the glass raw material. Further, the composition in the glass raw material used in this Example was almost the same as the composition of from “SiO₂” to “Fe₂O₃” in Table 5. Table 6 shows the properties, etc. of the glass in this Example. The method of this Example is the same as in the cases of Table 1 and Table 3.

Further, in a case where the mass of the glass is taken as 100 parts, the content of the ammonium salt in the raw material is substantially the same as the value of the mass ratio of the ammonium salt in Table 5.

Since the mass proportion of components other than from “SiO₂” to “K₂O” is a trace amount, the contents of from “SiO₂” to “Fe₂O₃” in the above obtained glass are the same as ones calculated from the values of from “SiO₂” to “Fe₂O₃” in Table 5.

Further, r and the dissolved NH₄⁺ in Table 6 were not measured, but, r is estimated to be from 0.96 to 0.99, and the dissolved NH₄⁺ is estimated to be at least 5×10⁻⁴%.

TABLE 5

| Example | 13 |
|---|---|
| SiO₂ | 57.8 |
| Al₂O₃ | 6.9 |
| B₂O₃ | 0 |
| MgO | 2.0 |
| CaO | 5.0 |
| SrO | 7.0 |
| BaO | 8.0 |
| ZrO₂ | 3.0 |
| Li₂O | 0 |
| Na₂O | 4.3 |
| K₂O | 6.0 |
| Fe₂O₃ | 0.10 |
| Ammonium salt | (NH₄)₂HC₆H₅O₇ |
| Amount of ammonium | 3.19 |
| salt to be added | |
| NH₄⁺ | 0.51 |

TABLE 6

| Example | 13 |
|---|---|
| r | Not |
| Dissolved NH₄⁺ | Not |
| β-OH | Not |
| Number of bubbles | 50 |
| Transmittance | Not |
| (546 nm) | |
| Transmittance | Not |
| (300 nm) | |
| Specific gravity | 2.77 |
| Thermal expansion | 83 |
| coefficient | |
| Tg | 620 |
| Strain point | 570 |
| Young's Modulus | 76 |
| HCl durability | <0.01 |

Industrial Applicability

According to the present invention, it is possible to obtain glass having a small number of bubbles even by incorporating neither As₂O₃ nor Sb₂O₃ and even without containing SO₃. Such glass is suitable for a glass substrate for display (particularly for a glass substrate for TFT-LCD).

Further, by melting a raw material containing neither As₂O₃ nor Sb₂O₃, the glass having a small number of bubbles can be obtained. This method is particularly suitable for producing alkali-free glass to be used for a glass substrate for TFT-LCD.

The entire disclosure of Japanese Patent Application No. 2002-168847 filed on Jun. 10, 2002 including specification, claims and summary is incorporated herein by reference in its entirety.

1. Glass having a reduction degree such that Fe²⁺/(Fe²⁺+Fe³⁺) is at least 0.61, as the reduction degree of glass is represented by a ratio of Fe ions.

2. The glass according to claim 1, which comprises, as represented by mass percentage, at least 40% of Si as SiO₂ and at least 0.0015% of Fe as Fe₂O₃, wherein Fe²⁺/(Fe²⁺+Fe³⁺) is at least 0.8, and NH₄⁺ or Cl is contained.

3. The glass according to claim 1, wherein the content of Fe as Fe₂O₃ is at most 0.3%, as represented by mass percentage.

4. The glass according to claim 3, wherein the content of Fe as Fe₂O₃ is at least 0.0015% and at most 0.2%, as represented by mass percentage.

5. The glass according to claim 1, which contains, as represented by mass percentage, from 0.0001 to 0.01% of NH₄⁺.

6. The glass according to claim 5, which contains, as represented by mass percentage, from 0.0004 to 0.001% of NH₄⁺.

7. The glass according to claim 1, which contains, as represented by mass percentage, from 0.03 to 1% of at least one element selected from the group consisting of Cl, F, Br and I.

8. The glass according to claim 7, which contains, as represented by mass percentage, from 0.05 to 1% of Cl.

9. The glass according to claim 1, wherein the content of Si as SiO₂ is at most 80%, as represented by mass percentage.

10. The glass according to claim 1, which contains, as represented by mass percentage, from 40 to 80% of SiO₂.

11. The glass according to claim 1, wherein no S is contained, or if S is contained, its content as SO₃ is at most 0.005%, as represented by mass percentage.

12. The glass according to claim 1, wherein neither As nor Sb is contained, or if As and Sb is contained, the total content as As₂O₃ and as Sb₂O₃ is at most 0.1%, as represented by mass percentage.

13. The glass according to claim 1, wherein no Sn is contained, or if Sn is contained, its content as SnO₂ is at most 0.02%, as represented by mass percentage.

14. The glass according to claim 1, which contains at least one element selected from the group consisting of Al, B, Mg, Ca, Sr, Ba and Zn, and the contents based on the following oxides as represented by mass percentage, are from 0 to 35% of Al₂O₃, from 0 to 25% of B₂O₃, from 0 to 50% of MgO+CaO+SrO+BaO+ZnO and from 19 to 59% of Al₂O₃+B₂O₃+MgO+CaO+SrO+BaO+ZnO.

15. The glass according to claim 14, which comprises, as represented by mass percentage:

| | |
|---|---|
| SiO₂ | 45 to 70%, |
| Al₂O₃ | 5 to 25%, |
| B₂O₃ | 1 to 20%, |
| MgO | 0 to 10%, |
| CaO | 0 to 15%, |
| SrO | 0 to 15% and |
| BaO | 0 to 20%. |

16. The glass according to claim 14, which comprises as represented by mass percentage:

| | |
|---|---|
| SiO₂ | 50 to 75%, |
| Al₂O₃ | 0 to 15%, |
| B₂O₃ | 0 to 10%, |
| R₂O (R represents Li, Na or K) | 6 to 24%, |
| R′O (R′ represents Mg, Ca, Sr or Ba) | 12 to 27%, and |
| ZrO₂ | 0 to 10%. |

17. The glass according to claim 1, which has a transmittance of light having a wavelength of 546 nm being at least 85% when its thickness is 0.7 mm.

18. The glass according to claim 1, which has a transmittance of light having a wavelength of 300 nm being at least 60% when its thickness is 0.7 mm.

19. A method for producing glass, which comprises melting raw material to produce glass comprising, as represented by mass percentage, at least 40% of Si as SiO₂, characterized in that the raw material contains an ammonium salt (except for ammonium sulfate and ammonium nitrate).

20. A method for producing glass, which comprises melting raw material to produce glass comprising, as represented by mass percentage, at least 40% of Si as SiO₂, characterized by feeding an ammonium salt (except for ammonium sulfate and ammonium nitrate) to molten glass obtained by melting the raw material.

21. The method for producing glass according to claim 19, characterized in that the ammonium salt (except for ammonium sulfate and ammonium nitrate) is added to the raw material of glass in an amount of from 0.1 to 10 parts per 100 parts by mass of glass obtained by melting the raw material.

22. The method for producing glass according to claim 20, characterized in that the ammonium salt (except for ammonium sulfate and ammonium nitrate) is added to the raw material of glass in an amount of from 0.1 to 10 parts per 100 parts by mass of glass obtained by melting the raw material.

23. The method for producing glass according to claim 21, wherein the ammonium salt is at least one member selected from the group consisting of an ammonium halide, ammonium borate or an ammonium salt of an organic acid.

24. The method for producing glass according to claim 22, wherein the ammonium salt is at least one member selected from the group consisting of an ammonium halide, ammonium borate or an ammonium salt of an organic acid.

25. The method for producing glass according to claim 21, the ammonium salt is ammonium chloride.

26. The method for producing glass according to claim 22, the ammonium salt is ammonium chloride.

27. The method for producing glass according to claim 19, wherein no sulfate is added to the raw material of glass, or a sulfate is added to the raw material of glass in an amount of at most 0.01 part as SO₃ per 100 parts by mass of glass obtained by melting the raw material.

28. The method for producing glass according to claim 20, wherein no sulfate is added to the raw material of glass, or a sulfate is added to the raw material of glass in an amount of at most 0.01 part as SO₃ per 100 parts by mass of glass obtained by melting the raw material.

29. The method for producing glass according to claim 19, wherein neither As nor Sb is added to glass, or As and Sb are added to the raw material of glass in an amount of at most 0.1 part as As₂O₃ and Sb₂O₃. per 100 parts by mass of glass obtained by melting the raw material.

30. The method for producing glass according to claim 20, wherein neither As nor Sb is added to glass, or As and Sb are added to the raw material of glass in an amount of at most 0.1 part as As₂O₃ and Sb₂O₃. per 100 parts by mass of glass obtained by melting the raw material.

31. The method for producing glass according to claim 19, wherein no SnO₂ is added to glass, or SnO₂ is added to the raw material of glass in an amount of at most 0.03 part per 100 parts by mass of glass obtained by melting the raw material.

32. The method for producing glass according to claim 20, wherein no SnO₂ is added to glass, or SnO₂ is added to the raw material of glass in an amount of at most 0.03 part per 100 parts by mass of glass obtained by melting the raw material.
